(19) United States
(12) Patent Application Publication
(10) Pub. No.: US 2024/0168822 A1
(43) Pub. Date: May 23, 2024

(54) System and Method Of Annotating Data Models Allowing The Factoring In Or Out Of Recurring Events To Improve The Outcome Of Predictive Systems

(71) Applicant: Tangoe US, Inc., Stamford, CT (US)

(72) Inventors: Dawn Michele Preston, Cleveland, GA (US); Paolo Sellari, Shelton, CT (US); Jaan Leemet, Aventura, FL (US)

(21) Appl. No.: 18/459,235

(22) Filed: Aug. 31, 2023

Related U.S. Application Data
(60) Provisional application No. 63/426,452, filed on Nov. 18, 2022.

(51) Int. Cl. G06F 9/50

(52) U.S. Cl. CPC G06F 9/5055

(57) ABSTRACT

Systems and methods for monitoring hosted computing resource usage wherein software receives usage information of a software application executing on at least one of a plurality of computing resources to determine anomalies in usage and the software accessing external sources to identifies a predicted future anomaly and modifies availability of computing resources for execution of the software application as a way to improve the outcome of data modelling by recognizing repeated anomalous patterns and allowing these to be factored in or out of the predictive modelling.

### FIELD OF THE INVENTION

The following relates to predictive data modelling of data usage for cloud applications, particularly the recognizing, annotating, and selectively factoring in and out of specific recurring anomalous events so as to improve a predictive model's accuracy.

### BACKGROUND OF THE INVENTION

Predictive analysis is used extensively to forecast usage with applications to growth forecasting, cost modeling and more. However, there may be periodic anomalies which can skew results that make modelling based on historical data more difficult and lead to inaccurate forecasts.

These can include seasonal spikes such as ‘sales’ or ‘events’ which trigger more traffic, as well as ‘closures’ or ‘slowdowns’ that trigger less traffic. While the patterns associated with these events can be modeled, the timing of the anomalous events is not predictable.

These anomalies should not be construed as normal usage and should not be used in normal usage predictions. They do not factor into the typical usage models and should not be used for future growth requirements or costing estimates. Even when events repeat at longer frequencies, the typical modeling of data from day to day, week to week or month to month (to follow typical billing cycles) is skewed and offset by the anomaly. While it is true that systems may learn of this behavior on a yearly basis after some time, variations in the sale dates, or even the cancellation of the sale one year would cause confusion in the learning models and add a lingering impact that affects a models accuracy.

U.S. Pat. No. 8,887,286 Continuous anomaly detection based on behavior modeling and heterogeneous information analysis teaches how to implement a continual anomaly detection loop and how to bring anomalies to the attention of a user but does not teach a way of annotating or including/excluding the anomalous behavior in subsequent plots or predictive analysis. The system also does not teach now to isolate and recognize anomalies in more dynamic work environments where there are regular fluctuations in usage.

U.S. Pat. No. 11,308,049 Method and system for adaptively removing outliers from data used in training of predictive models teaches a method to adaptively remove the outliers and to preserve models. These changes in usage as used for training data for machine learning. The system proposed however does not teach how users can dynamically include or remove these outliers as anomalous events, which may occur such as opening a new office or doing a yearly inventory counting.

It would therefore be beneficial to have a system and method that could identify and use anomalous outlier events to improve predictive capabilities of modeling software by allowing the detection, annotation, and selective inclusion of such outliers for predictive modeling.

### SUMMARY OF THE INVENTION

It is a therefore an object of the present invention to provide a system and method for monitoring resource utilization in cloud applications and providing the captured data as input to modeling tools.

It is a further object of the proposed invention to provide a system and method that can set thresholds to detect outliers and anomalous events in the typical resource usage.

It is a further object of the system to provide insights through reporting of changes in the typical usage and resource needs of the system.

It is a further object of the invention to use such data for predicting the processing and resource needs of a cloud system in order to have adequate and optimal processing power for the system's needs.

It is a further object of the proposed invention to allow users of the system to detect, group, and isolate such outlier events such that they can be annotated and labeled.

It is yet another object of the invention to allow users to selectively include the annotated outliers for subsequent modeling, introducing the annotated outlier events into the calculations for when recurring anomalous events are expected to occur and removing them when they are expected to be absent.

It is yet another object of the invention and further desired to provide a system and method that incorporates machine learning to predict and establish the usage patterns of the system based on historical data and the detected and annotated anomalous events.

It is still a further object of the system to use the expected usage predicted by such modeling to configure a cloud system automatically and proactively, requesting such resources dynamically.

Finally, it is an object of the present invention to provide an improved system and method for predictive modeling that can isolate and selectively include repeated anomalous events that affect data usage in a cloud system and thus affect hosting costs and resource needs.

The proposed system is able to recognize and isolate anomalous events. Subsequently, when modeling the data, the proposed system allows the user to annotate these events along with the resultant spike or drop in usage, isolating the events thus allowing them to be included or ignored in the modeling process. Cost estimation for resource utilization is adjusted accordingly which in turn leads to a more reliable and accurate model.

Thus, when a similar event is scheduled to take place in the future, the system can, apply data from previous occurrences of this event to the model adjusting current usage predictions and allowing for a more accurate forecast. This forecast may be used to scale up/down computing resources or otherwise prepare for expected large traffic spikes and reductions to allow computing performance to be maintained without over reserving resources. The predicted anomalies can thus be factored into the usage estimation model when they are expected to occur thereby improving the predictions made by the system.

As an example, say a company hosts a very popular ‘spring sale’. The system traditionally sees a large increase in demand and a spike in traffic. Prior usage spikes can be used to model and prepare system resources to ensure performance for future spring sales. Resultant costs in increased resource needs can be estimated allowing for both a more accurate usage and cost prediction. Models are created that overlay the ‘spring sale’ resource utilization deltas over the traditional forecast models thus adjusting or compensating for these changes in usage. As such, the system is better prepared to handle the spike in usage and users of the system do not suffer any degradation in performance.

As another example, say we expect a large increase in traffic when a new device model is to be introduced to the market as customers rush to be the first ones to have the new model. As the date approaches, we can forecast this increase based on previous releases of similar devices. The system can thus be prepared for the added traffic avoiding any latency or potential down time and the budget adjusted for the resultant increase in operational cost.

Similar examples to the above include a company opening a satellite office, closing an office, adding a new retail outlet, growing the number of salespeople, publishing an advertisement, adding a new product line, etc. While a certain amount of variation in resource utilization is normal and can be attributed to simple random traffic patterns, changes outside of a preestablished threshold are picked up and selectively included for annotation and cataloging within the system.

To that end, a system is provided that can predictively configure cloud resources to have adequate resources to perform optimally based on the modeling and predictions made within a pre-established budget. The system includes a set of robotic software programs running on one or more computers and a cloud-based software program collecting resource utilization data about a running application.

In one embodiment, the system collects resource utilization statistics and details from alerts received from the hosting provider upon which the application is running, modeling the resource utilization impact on the hosting cost of the application. Such resource use includes but is not limited to CPU utilization, bandwidth usage, memory, disk usage, and so on.

In another configuration the system relies on application self-monitoring through built in functions in the app to report and control resource usage behavior over time.

In yet another configuration the system uses a wrapper/container in which the app runs, and which acts as an intermediary for resource requests. The container/wrapper is thus able to monitor the resource utilization and provide control over the requests, including the timing and requests contents and the resulting allocation of the resources.

In one configuration a system and method are provided to generate patterns of data usage over time, providing threshold-based anomaly detection to recognize outliers. The duration of the outliers and the delta resource utilization is recorded and mapped so that the outlier events can be annotated and catalogued as a fixed amount of additional usage or reduced usage over a fixed amount of time on a particular date.

In another configuration a system and method are used to calculate the excess utilization as a relative increase in utilization over the anomalous event period. The percentage difference of the outliers and the delta resource utilization is recorded and mapped so that the outlier events can be annotated and catalogued as a variable and relative amount of additional usage or reduced usage over a fixed amount of time on a certain date.

In yet another configuration a system and method are provided to predict future resource utilization based on historical data and trends measured and recorded by the system.

The system further includes the ability to include or remove the annotated anomalous events or occurrences, whether by fixed amount of additional resource use or by relative percentage of increased use in creating future modeling of resource usage in a modeling calculation.

In yet another configuration the system further includes the ability to automatically request additional resources from the hosting provider to provision or decommission resources as predicted by the model.

In one example, if a store wide sale takes place, a burst of activity may occur in a given month during the days of the sale. A large increase in activity across the network of stores using the application for order entry and sales is seen by the system and measured. The CPU utilization and the application memory use will in all likelihood be much larger than “normal” to handle the increase in transactions and activity. The number of additional resources required for these sale events is predictable and can be calculated by the system and the fixed or relative amount of increased resource utilization can be predicted based on prior measurements using historical data from prior such sales events. What is unknown is the exact timing of when the sale event will occur, which can be provided as an input to the system. In some instances, the system can also automatically detect the beginning of a pattern, which suggests a given event is starting to occur. It is contemplated that once an event is automatically detected, additional resources can be automatically secured based on historical data to handle the increased volume.

In modeling the future resource use and configuring the computing environment to accommodate the predicted burst of use in an economical manner the system ensures optimal costs and adequate performance for the expected burst of activity. Knowing the application resource use profile, the system can predict the various resources needed to accommodate the increased traffic needs. The system also knows how to adjust the hosting platform configuration and can automatically adjust the resource profile it uses based on these estimations and predictions.

The system allows for a given amount of variance from typical resource utilization in normal day to day operation. Using machine learning, patterns are established which become the normal activity profile. Variations to this normal profile within a set of thresholds is considered normal, but once a threshold is crossed, the utilization is flagged as anomalous.

The system begins tracking the anomalous usage over time starting from the initial detection and continuing until the usage pattern again returns to the “normal” pattern. A time limit is also established, to allow for anomalous events which will affect usage variations in a permanent fashion. For example, the addition of new features, the release of a new product, or the opening of a new retail outlet.

These events are flagged, and if the system is configured to allow dynamic predictive adjustments to be made it will automatically configure a new resource profile for the application.

The models contain resource utilization profiles including the required amounts of specific resources such as memory, disk, computational power, and bandwidth. These are kept in a table format whereby the resources can be mapped to the existing hosting plan and matched to ensure adequate capacity has been provisioned. The system is also familiar with the hosting plan models to allow for the most economical selection for provisioning the necessary resources. These hosting models include fixed hosting plans as well as a-la-carte options which may be represented as overage fees. In many cases, the hosting models and billing parameters vary from vendor to vendor and these values are normalized and shown in the table which forms a superset of all of the available models so as to remain flexible across providers.

For example, a basic hosting plan may allow for 100 TB of disk storage while a premium plan may allow for 500 TB. Typically, if one is on the basic plan and uses more than the allocated 100 TB of disc space, the system charges a higher per TB overage fee. If the cost per TB in the plan is calculated at 10 c, the overage fee may be as much as 20 c or even 50 c per TB.

Continuing with the example above, if the system modeling is predicted to use 110 TB, it may be more cost effective to keep a basic plan with 100 TB and pay for 10 TB of overage costs instead of moving to the more expensive 500 TB premium plan. This will depend on the expected amount of the overage along with the overall overage cost and the incremental cost across plans.

The system and method further comprise the development of a reporting and alerting system which allows administrators to take manual action on certain events with key information on hand such as increasing the modeling relative to other parameters. For example, while last year's spring sale may be brought about 20,000 more transactions, the overall transaction count on a normal day may now be twice as large. An administrator my opt to adjust the estimated increase in resources for the sale to provide 40,000 new transactions this year even if the system predicts 20,000.

While these manual adjustments are always possible, over time the system adjusts its estimates based on machine learning and can make better predictions considering the normal day to day sales volume and many other factors including: seasonality, the time since the last sale, the day of the week, the duration of the sale, the amount of marketing budget allocated, among others factors.

External feeds can also be established to gain insights into traffic affecting events. These may be RPAs created to monitor sites such as weather and local events or external feeds that are read and parsed to create the needed inputs.

For example, it may be understood that a company is increasing their advertising budget in the coming year and therefore expect this adjustment to generate a 25% increase in sales, and thus the expected volume would be modeled and predicted by the system accordingly.

When making the adjustments, the system allows the administrator to provide insights to the system as to why the predictions are being adjusted and the system can use these factors as part of its machine learning algorithms for future use.

The system and method still further comprise the use of machine learning used to assist with the modeling where prior behaviors and changes in transaction volume are reported. The machine learning will learn from the prior behaviors and volume changes to provide better predictive capabilities to adjust for these scenarios.

Therefore, the stated and other objects of the invention are achieved by providing a computer-implemented method for detecting, isolating, and allowing the selective inclusion of anomalous events comprising increased or reduced resource utilization in the predictive modeling and subsequent resource allocation of computing systems used to provide a cloud-based application or service.

Computing requests by a software application executing on at least one of a plurality of computing resources associated with a first hosting provider, the software application associated with a first hosting plan, which relates use of the computing resources to a cost of executing said software application on the at least one of the plurality of computing resources; and determining, with the software program, one or more of the computing requests so that the prediction of one or more parameters of use of the computing resources remain below one or more thresholds associated with the selected hosting plan to optimize the costs allowing the optimal plan to be provisioned for the expected resource utilization.

In certain aspects the one or more parameters of use are selected from the group consisting of bandwidth, disk space, memory (RAM) and processing (CPU). In other aspects the one or more thresholds are indicative of a total amount of usage of the one or more parameters for a defined period of time. In yet other aspects the software program is part of the software application.

Objects of the invention are achieved by providing a system for monitoring hosted computing resource usage by applications. The system can include a software program executing on a computer, the software program receiving computing requests by a software application executing on at least one of a plurality of computing resources associated with a first hosting provider, the software application associated with a first hosting plan, which relates use of the computing resources to a cost of executing said software application on the at least one of the pluralities of computing resources.

In certain aspects the software program provides a method for users to supplement automated system modeling that is based on historical data. Using machine learning and machine intelligence allows the system to predict certain events or changes in usage. However, there are some events that, while the characteristics of the event (such as the number of additional resources required) may be predictable, predicting the actual timing of the event itself is difficult. This may be because the timing of the event is heavily influenced by some external factors. These factors may involve: the availability of new products, the end of a sales quarter where sales numbers are down, or even a holiday schedule or a weather forecast. It should be noted however, there is always some amount of notice, even if relatively small, available for when the event is to be had. This notice, coupled with the knowledge of resource requirements associated with the event, and the ability to predict, model, and automatically allocate and obtain such resources, does provide substantial benefits.

In addition, when modeling the data to forecast system growth, the system provides a checklist of events, which can be taken out of the modeling equation. In a growth model where 10% more traffic is expected, the ‘spring sale’ traffic would be deselected so as not to skew the overall results in calculating the expected forecast. If sales at regular intervals are scheduled, they can be added to forecasts in the time periods where predictions are calculated.

As a further example, consider a company that is in expansion and opening new sites or franchises. A central cloud application provides support and business functionality for the business functions needed to operate the new site. The timing of openings is unpredictable and often delayed with construction or permit delays. Knowing the resource requirements and load generated by a new site, allows for the appropriate provisioning of back-end resources for the launch of the new site based on modeling of prior or historical openings.

In such a case, a new site may have additional business from the launch due to extensive marketing and awareness campaigns in the local area. The model may consider the initial launch spike and subsequent resource requirement needs, as well as the stable day-to-day needs in adding the new franchise or location.

While the above example describes a franchise or retail store outlet, such reasoning could be extended to a new office location or any type of facility small or large. The modeling can incorporate a ramp up of resources brought about by hiring over a longer period, such as bringing on board a staff of engineers or salespeople for such a site or executing a merger or acquisition.

Even for an existing department, when a budget increase is provided that allows for the growth via hiring. Similarly, the model will work for scaling down a department with decreases in headcount and the closing of sites.

Each of these cases becomes a known quantity, annotated by the administrator and events can be selectively included or excluded from the modeling calculations. When added or removed, the system can automatically provision the appropriate sized resources for the system when the events are modeled to occur.

The detection by the system of the spikes in resource usage is triggered via machine learning based on the expectation in resource utilization within the expected threshold and is flagged and brought to the attention of the administrator.

In another configuration, the administrator is aware of an atypical event (e.g., a spring sale), and notifies the system of the pending activity. In such a case, the system gathers information over the expected time and duration of the event and uses machine learning to capture and model the anomalous activity, which can be used for future modeling and prediction.

Take a scenario where, the first of what is expected to be a recuring sale is to be had on an upcoming weekend. The administrator annotates a time period starting Saturday at opening time and finishing Sunday at closing time annotating the event as ‘Surprise Weekend Sale’. Being the first such event, the system requests additional resource-impacting details from the administrator, such as, the expected increase in sales or traffic for the event.

The operator may then enter a best guess of the expected volume, whereby the system then monitors, measures, and characterizes the newly annotated event as it occurs.

In some configurations, when the best guess comprises a large error bar (whether underestimated or overestimated) and the system is underperforming or overperforming with a lack or excess of resources respectively, the system may autonomously take action to reconfigure midway through the event to better match resources with actual observed demand.

After the event has elapsed, the actual change in predicted usage can be determined as an overlay of the normal usage. This could be a comparison of, for instance, the actual usage as compared to the normal average weekend usage. This excess amount could then be the amount (or a scaled amount) used when the annotated value of ‘surprise weekend sale’ is selected for subsequent sales. The operator may further have the ability to provide for some adjustments in the predictive model. For example, if the weather negatively impacted the event preventing people from taking advantage of the sale otherwise, it could be decided that it would be appropriate to adjust the expected sales for such an event to a higher level than was actually seen at the present event.

Now, when the second such similar sale is to be had, the system then predicts the traffic and resource needs based on the historical data of the prior event. However, as stated previously the administrator can adjust the estimated traffic and increase in sales if desired. Such adjustments could be for example, due to a clear weather forecast during the event; or because a new series of very popular products are to be introduced; or due to increased marketing for a product(s) allowing for increased promotional activities; or because widely advertised sales prices are to be reduced leading to more sales volume.

Over time, with multiple weekend sale events having occurred, the machine learning aspect of the system can determine that rather than using a fixed increase in usage, the system can be better modeled with a percentage change for resource loading. For example, an expectation of a percentage more traffic instead of a fixed number of shoppers.

Further integration with other software elements such as point of sale terminals or sensors can aid in prediction accuracy by mapping real time foot traffic to expected resource utilization which can often be allocated and adjusted in near real time to cope with any under or over estimated modeling.

It should be noted that while the examples above often use processor power or traffic as parameters to be used in the modelling, such modelling can be performed on most any measurable elements and will in most cases be mapped to cost and system performance and may vary from one provider to the next. As an example, if one provider offers dynamic memory allocation in increments of 1GB where-as another only offers three tiers of memory, a closer monitoring and modeling of memory allocation can be used to optimize the system and the operational costs. In essence, other variables which may become present in future billing models that can be monitored can thus be dynamically added to the system modeling and used by the machine learning system.

It should also be noted that while the system above is described to model resources used by the cloud application, there are also parallels to the inventory to be stocked, staff to be hired, or machines to populate an automated fulfilment factory. There are multiple applications for the models used in the system across many domains.

The system also uses machine learning to model gradual and normal organic growth. One objective of the system is to use this machine learning based modeling to predict where costs will naturally go in coming months and/or years.

Additionally, benchmarking across systems can also provide insights into site efficiency and detect operational anomalies. Looking again at the franchise or retail outlet example, resource utilization for the cloud application should be closely modeled with the use of the app based on business volume. In such cases, when one site has a similar volume to another site but is seeing a different usage model, such comparison can lead to further analysis to see why the resource utilization is different (overused or underused) at a given site. This can add to further efficiency and also detect potential unauthorized activities.

Such a system provides many benefits over traditional modeling systems. These include the following:
a. Traditional modeling systems intake all data, which leads to skewing because of anomalous events. They don't allow the annotation and filtering in/out of these events.
b. Traditional systems are not autonomous but require user knowledge and tools to generate alerts and alarms and logs to calculate larger than expected costs. The present system will automatically perform all these functions and will do it in real time rather than after the fact when the need for resource adjustment has already past.
c. By automatically configuring the resource profile of the application, the system runs more efficiently and does not have to be overprovisioned initially and does not suffer degradation in performance when faced with increased resource requirements because it runs autonomously and adjusts dynamically

Other objects of the invention are achieved by providing a system for managing hosted computing resource usage by applications including a software program executing on a computer, the software program receives a plurality of computing requests by a software application executing on at least one of a plurality of computing resources associated with a first hosting provider, the software application associated with a first hosting plan, which relates use of the computing resources to a cost of executing the software application on the at least one of the plurality of computing resources. The software program determines a variance in the resource utilization that is above a set threshold that would be considered a “normal” operating variance and automatically labels this for administrator consideration.

The system may thus identify patterns of anomalies that are not otherwise apparent to the administrator or directly under the control of the operation. For example, rather than a predicted “spring sale”, the system detects an anomalous increase in traffic and creates an annotated event called ‘unknown increase’ which lasts a weekend. Upon examination of the data and discussion with the store clerks, the administrator realizes that there was actually a sale at a neighboring store that brought more customers into the general area, many of which came to the store increasing the volume of sales.

The administrator can choose to annotate the event adjusting the ‘unknown increase’ label to a neighboring store sale label and can potentially keep on the lookout for further sales that the system could account for in predictive modeling. The system can also perform data mining to search for potential traffic affecting events. The administrator can also choose to ignore the event or adjust the threshold detection system to allow for a larger variance so as not to flag such events in the future. It may depend upon the volume of increased resource demands and whether the system performed within expected parameters despite the increase in system demand.

Similar parallels can be drawn for example with external variables such as weather. The system may detect that there is a correlation with rainy days generating less traffic and less demand as shoppers do not want to go out. The system may also correlate local events, holidays and more with variances in traffic. If for example, a predictable pattern of increased traffic on Fri-Sat is determined, the system may decide to configure its resource profile to adjust for increases and decreases in traffic based on the day of the week.

Other objects are achieved by providing a system for managing hosted computing resource usage plans. A software program executes on a computer having a storage. The software program monitors computing requests by a software application executing on at least one of a plurality of computing resources associated with a first hosting provider. The software application is associated with a first hosting plan, which relates use of the computing resources to a cost of executing the software application on the at least one of the plurality of computing resources. The software program compares use of the computing resources, the first hosting plan and historical use of at least one of the computing resources to an alternate hosting plan to from the first hosting provider to determine if the alternate hosting plan would better meet expected needs based on the use and the historical use, and the software program transmitting instructions to a first hosting provider computer to switch from the first hosting plan to the alternate hosting plan. This analysis may be on the plan level or on an a-la-carte resource level. For example, a plan may include a fixed set of disk space, but if additional disk space is needed, the system can automatically order additional disk space or may relinquish disk space at variable costs even if not part of a given plan.

In certain aspects the software program determines the alternate hosting plan or a change in resources being used is likely to would better meet expected needs based on the software application being modeled.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object, or thing from another, and are not used to designate relative position or arrangement in time unless otherwise stated.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

In certain aspects a system is provided for monitoring hosted computing resource usage by applications. The system includes executing on a computer and the software receives usage information of a software application executing on at least one of a plurality of computing resources. The usage information is indicative of usage of the at least one of the plurality of computing resources by the software application. The software identifies usage variations based on the usage information and determining one or more anomalies in usage based on variation of usage compared to a threshold. The one or more anomalies are each tagged based on one or more event designators and the software accesses one or more external sources to identify an occurrence of an event associated with a predicted future anomaly in usage of the at least one of the plurality of computing resources and based on the event compared to at least one of the one or more event designators, said software modifying availability of computing resources for execution of the software application.

In certain aspects the software application is associated with a first hosting plan which relates use of the computing resources to a cost of executing said software application on the at least one of the plurality of computing resources. A cost limitation is associated with the software application such that the cost limitation limits an amount of modification of availability of computing resources as compared to the cost limitation.

In other aspects revenue information is accessible by said software, the revenue information indicative of revenue associated with the software application and wherein the cost limitation adjusts based on the revenue information. In other aspects the cost limitation is determined based on a ratio determined from usage information relative to the revenue information. In yet other aspects a user interface is provided by the software application and allows user access to tag the one or more anomalies. In other aspects the one or more external sources includes the software application. In still other aspects the one or more external sources includes one or more social media pages associated with the software application. In other aspects the usage information includes resource utilization statistics selected from the group consisting of CPU utilization, bandwidth usage, memory, disk usage and combinations thereof. In further aspects a baseline usage for the software application is determined by excluding at least one of the one or more anomalies and based on the predicted occurrence of the predicted future anomaly, availability of computing resources is modified for a period of time for an adjusted usage which includes the baseline usage and the at least one of the one or more anomalies. In yet further aspects the inclusion of the at least one of the one or more anomalies in the adjusted usage increases availability of computing resources.

Other objects are achieved by providing a method of monitoring hosted computer resource usage. The method includes one or more of the steps of: providing software executing on a computer, the software receiving usage information of a software application executing on at least one of a plurality of computing resources, the usage information indicative of usage of the at least one of the plurality of computing resources by the software application; with said software, identifying usage variations based on the usage information and determining one or more anomalies in usage based on variation of usage compared to a threshold; and said software accessing one or more external sources to identify an occurrence of an event associated with a predicted future anomaly in usage of the at least one of the plurality of computing resources and based on the event compared to a the one or more anomalies which are each a prior anomaly to the predicted future anomaly, said software modifying availability of computing resources for execution of the software application.

In certain aspects the software modifies availability of computing resources by sending an instruction to a host provider associated with the at least one of the plurality of computing resources. In other aspects the one or more anomalies are each tagged based on one or more event designators. In still other aspects the one or more event designators are compared to the event to determine a correlation between the event and the one or more event designators such that a size of the predicted future anomaly is predicted. In still other aspects the size of the predicted future anomaly determines how said software modifies availability of computing resources. In yet other aspects the software application is associated with a first hosting plan which relates use of the computing resources to a cost of executing said software application on the at least one of the plurality of computing resources; and an amount of the modification of availability of computing resources is determined in comparison to a cost limitation associated with the software application.

In still other aspects the method includes accessing revenue information with said software, the revenue information indicative of revenue associated with the software application and wherein the cost limitation adjusts based on the revenue information. In other aspects the cost limitation is determined based on a ratio determined from usage information relative to the revenue information.

Other objects are achieved by providing a system for monitoring hosted computing resource usage. The system includes software executing on a computer, the software receiving usage information of a software application executing on at least one of a plurality of computing resources. The usage information is indicative of usage of the at least one of the plurality of computing resources by the software application. The software identifies usage variations based on the usage information and determining one or more anomalies in usage based on variation of usage compared to a threshold. The software further accesses one or more external sources to identify an occurrence of an event associated with a predicted future anomaly in usage of the at least one of the plurality of computing resources and based on the event compared one or more anomalies in usage which are past anomalies and based on the comparison, said software modifying availability of computing resources for execution of the software application.

In certain aspects the software application is associated with a first hosting plan which relates use of the computing resources to a cost of executing said software application on the at least one of the plurality of computing resources. A cost limitation is associated with the software application such that the cost limitation limits an amount of modification of availability of computing resources as compared to the cost limitation. In certain aspects revenue information is accessible by said software, and the revenue information is indicative of revenue associated with the software application and wherein the cost limitation adjusts based on the revenue information. In other aspects the cost limitation is determined based on a ratio determined from usage information relative to the revenue information.

Other objects of the invention and its particular features and advantages will become more apparent from consideration of the following drawings and accompanying detailed description.

### BRIEF DESCRIPTION OF THE DRAWINGS

FIG. 1A is a block diagram of the predictive modeling system according to one configuration of the invention.

FIG. 1B is another block diagram showing further details of the system of FIG. 1A.

FIG. 1C is a flow chart showing a process according to FIGS. 1A-B.

FIG. 2 is a process diagram of the predictive models according to the present invention.

FIG. 3 is a flow diagram illustrating detection and cataloging of anomalous events within the system according to FIG. 1.

FIG. 4 is a flow diagram illustrating how the system determines known trends within anomalous events and triggering resource changes within the system according to FIG. 1.

FIG. 5 is a flow diagram illustrating the systems reporting and modeling capabilities according to FIG. 1.

FIG. 6 is a flow diagram illustrating a tabular representation of the systems resources and available plan mappings according to FIG. 1.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

The present invention relates to systems and methods for detecting and annotating anomalous usage patterns for resource utilization in cloud-based software as part of service expense management. RPA (Robotic Process Automation) agents, ETL (extract, transform, and load) tools or components, services, and functions are deployed as part of a resource modeling engine to monitor application activities detecting and establishing trends, patterns, and recognizing anomalies through resource monitoring. The RPA agents report metrics to the resource modeling engine, which uses machine learning to detect and identify anomalous patterns and trends and annotates these.

Administrators can also create manual events based on past modeling data annotating these. The anomalous events are stored as models in an annotated model's database and can be selectively included or excluded from modeling calculations and reports.

Further, based on the modeling, dynamic adjustments to platform resources are done so as to optimize the application resources and the subsequent cost and performance.

Further, the RPA automates decision making applying machine learning to detect the anomalous events.

The software program provides systems and methods to correlate the resource utilization metrics, whether from the RPA bots or from service provider platform notification systems, comparing the resource usage (such as computing load, bandwidth) with expected threshold values to determine if notifications should be isolated and annotated as anomalous events.

Administrators are able to adjust and name these anomalous events and then select or deselect them (essentially adjusting the predicted usage calculations accordingly). This can also trigger automated actions, such as changing plan parameters or adjusting resource availability from the hosting provider. Dynamic adjustment of thresholds based on known patterns such as daily or weekly busy periods, seasonality, external events are accounted for in the systems projections and analysis. Thresholds to monitor both unexpectedly large resource usage or unexpectedly small resource usage respectively above or below the established thresholds, is captured and reacted to accordingly.

Cloud computing platforms have become increasingly prevalent in the IT space allowing companies to run their applications on state-of-the-art infrastructures at a reasonable monthly cost, rather than making initial up front capital investments in building out their own hardware infrastructure.

With the hosted model, maintenance and upgrades of these services are all taken care of by the hosting providers in a turn-key fashion with the costs factored into a monthly operational expense. Various service models are offered that can respect SLA (Service Level Agreements) to meet a customer's needs. The customer does not have to build out an experienced IT team to manage and maintain their apps and does not need to worry about applying security patches, doing backups, or upgrading and replacing the hardware. The burden of ensuring uptime, availability, and redundancy and much of the liability for doing so rests with the hosting provider. The customer, or application provider, simply manages their own application within the given infrastructure.

The hosting providers provide billing models that factor in the application size, the amount of memory and disk needed, and the computing power required. A myriad of metrics is often applied to these billing models, which, now without an experienced IT department, the customer may not fully appreciate or understand. Additional overage costs may be added for transactional volumes, concurrent users, peak amounts of bandwidth or processing demands, turning what looked like a good fit on paper into a challenge of how to contend with unexpected monthly costs and budget overruns.

Providers have come up with their own billing models that map to resource usage in different ways. This is often hard to measure and difficult to predict for applications. When deploying an application, it may be difficult to determine which billing model will be the most appropriate based on the applications resource needs. These billing models can charge variable amounts per resource, and these can vary based on resource utilization thresholds. They may be a step function whereby you can get additional resources, for example disk space, in increments such as gigabytes.

When considering large scale applications with a large group of users, the hosting costs can be considerable. It is also essential that the system provide optimal performance for users, or the user experience may be such that users would abandon the system, with a potential loss of sales.

It would thus be highly desirable to have a system capable of detecting and predicting resource usage requirements that can be tailored to include anomalous events such as periodic sales and other changes while keeping the system running with optimal resources maximizing performance while limiting cost to a minimum required amount.

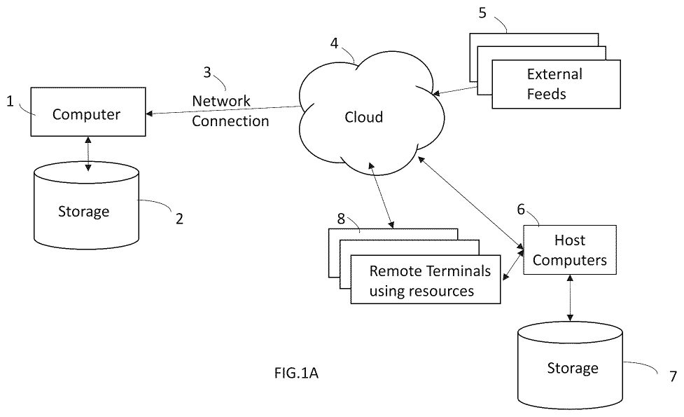

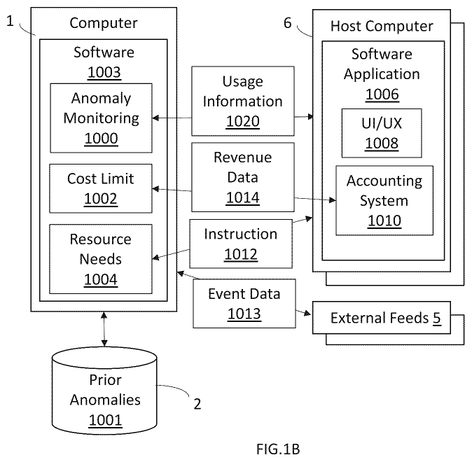

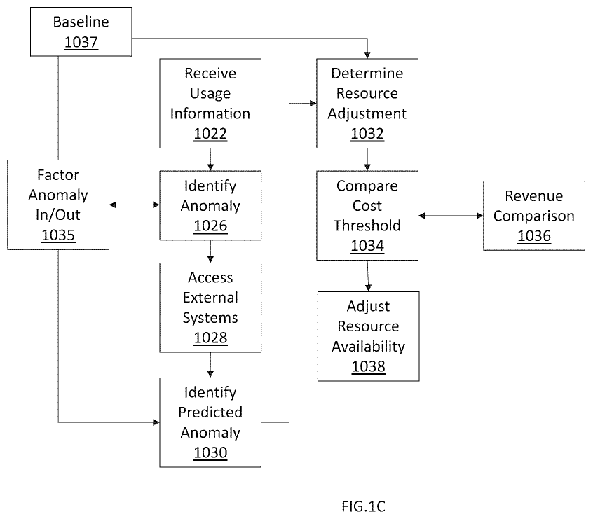

Referring to FIG. 1A we see a block diagram highlighting the various components of the predictive modeling system. A computer 1 is connected to a storage 2 and communicates over a network connection 3 through the cloud 4 to collect external feeds 5 as well as configure hosting parameters from a hosting provider 6. The hosting provider is coupled to a storage 7, which the hosting provider can access to provide data relating to resource provisioning and the like.

Also shown in FIG. 1A is a plurality of remote terminals using resources 8, which correspond to various locations that use resources. These could include for example, but are not limited to, store or retail locations, or any other type of location that is using resources provided by the hosting provider 6. The computer 1 is coupled to the remote terminals 8 via the cloud 4 for receiving data from the remote terminals 8 relating to resource usage.

As shown in FIG. 1B, the host computer 6 includes the software application 1006 executing thereon which provides, for example a User Interface 1008 and may also have an accounting system 1010. This accounting system may track sales, for example from an e-commerce website or may track other forms of revenue such as ad revenue, e.g. for publishers of online content. These are but some examples. It is understood that the host computer 6 may include multiple computers and the software application 1006 may include multiple software applications executing on different computers which work together to accomplish various tasks. The system computer 1 is provided with software 1003 which monitors usage information 1020 of the host computer 6 to monitor for and identify anomalies in usage 1000. These anomalies then are stored in the storage 2 as prior anomalies 1001 that can be used to compare to events 1013 determined from external feeds 5 to then predict future anomalies. Upon prediction of a future anomaly based on the event data 1013, the resource needs 1004 are determined and an instruction 1012 is generated. This instruction 1012 may be revised based on the cost limit 1002. Such a cost limit may further be revised based on revenue data 1014. Particularly, the accounting system 1010 can be accessed to determine the increase in revenue as a result of increased usage. For example, large spikes in usage may go well above the cost limit 1002 rather quickly, however, if there is a sufficient increase in revenue as a result, that cost limit should not slow down the system as doing so would reduce revenue. The relation of cost limit to revenue would depend on the usage information 1020. Namely a ratio of usage to revenue would be determined and the cost limit adjusted up as revenue increases in an amount commensurate with usage. This ratio may be a proportionate ratio or may be a variable ratio. For example, periods of much higher traffic may result in less revenue per usage metric in comparison to regular levels of traffic. There may be a natural decreasing conversion rate of sales or clicks or whatever else drives revenue. The anomalies of different types can each have their own pattern and the ratio and the resulting cost limit can be determined dynamically. Since the hosting plan correlates usage of different resources and usage types to a cost, the increase in resource availability may be more expensive than what is commensurate with the cost of reserving those resources. As the hosting plan changes, the ratio may change. On example of the cost limit may be a cost of hosting per impression as compared to the value of each impression. The impression values may decrease as the number of impressions increase as well. This would be determined from the accounting system. An impression is used in the internet advertising field in a manner that each impression usually has a cost per impression. For a publisher, the cost per impression is one driver of the revenue of the company, but if the cost of hosting in high levels of impressions (usage) has a decreased cost per impression, the cost limit allows the system to not overrun the costs of hosting to provide those impressions if the revenue decreases.

Referring to FIG. 1C, an example process the system implements is shown. The usage information is received 1022 and the software identifies anomalies in usage 1026. External systems are accessed 1028 and may correlate or tag those anomalies for future reference. The external systems can also be accessed 1028 at a later time to predict an anomaly 1030. An adjustment in resources is then determined 1032. If the anomaly is an increase in usage, this would likely mean reservation of additional resources to ensure the system does not crash and lock out users who could make purchases or otherwise drive revenue. If there is a decrease in usage anticipated, reduction of resources may be indicated. The resource adjustment to respond being determined results in a comparison to the cost threshold 1034 to determine if the cost limit will be exceeded. The cost limit may be adjusted based on a revenue comparison 1036 as previously discussed. Then the resource availability is adjusted 1038. The anomaly may be factored in/out of a baseline usage 1037 which can impact resource adjustment 1032 as the “normal” usage. The baseline 1037 would typically be considered the normal usage expectations and then upon the prediction of the anomaly 1030 and whether that anomaly was already factored in/out 1035, the resource adjustment 1032 can be determined based on the predicted occurrence of the anomaly. This anomaly may be a reduction in usage or an increase in usage and may be an increase/reduction in a variety of different metrics that go into the resource usage and availability. This could include an adjustment in availability of resources for variances in CPU utilization, bandwidth usage, memory, disk usage and combinations thereof.

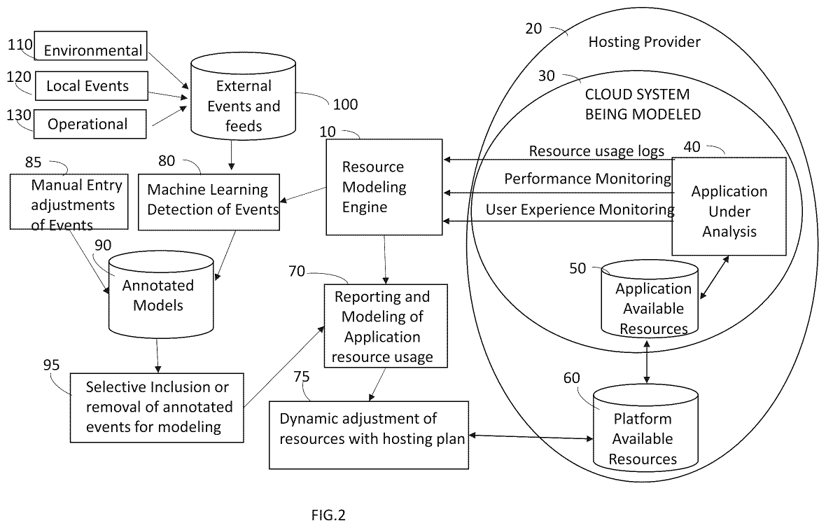

Referring to FIG. 2 the components of a predictive modeling inclusion system are illustrated. The resource modeling engine 10 captures resource usage from an application under analysis 40.

The application under analysis 40 is part of a cloud system being modeled 30, which is running on a hosting provider 20 cloud instance. The application under analysis 40 is using resources 50, which have been provisioned from an available pool of resources 60 on the given hosting provider 20.

The resource modeling engine 10 captures data from the application under analysis such as: resource usage logs, performance monitoring data, user experience data, and other similar data. The data is used to model system predictions 70, which are used for the dynamic adjustment 75 of system resources used by the application 40 within the hosting provider 20 cloud system 30 being monitored.

In capturing the usage modeling data from the application under analysis 40, the resource modeling engine 10 detects anomalous events through machine learning 80, and annotates these events in an annotated model's database 90. Similarly, administrators can also manually edit or create events 85 in the annotated models 90 database, which may comprise time-based usage sequences.

The system also uses external feeds 100, which include, but are not limited to, environmental inputs such as weather, local events that may impact foot traffic, and operational changes such as variations in price, and the addition/release of new products.

When performing the reporting and modeling functions 70 of the system, it is contemplated that an administrator could selectively include 95 or remove the anomalous events in prediction models.

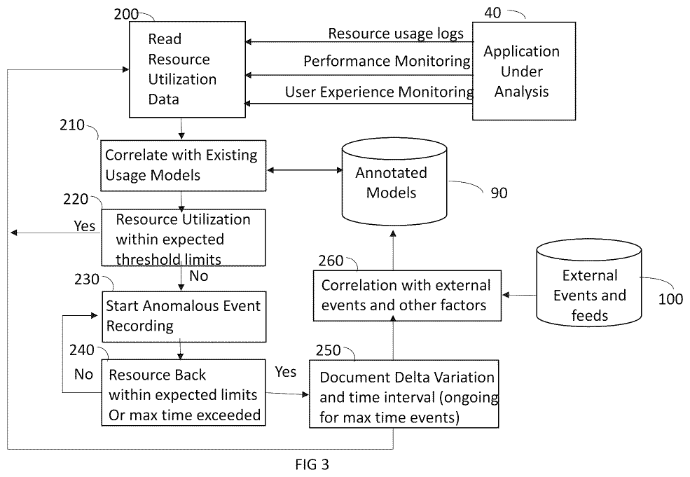

Referring now to FIG. 3, detection and cataloging of anomalous events by the system is presented. The system reads the resource utilization data 200 from the application under analysis 40, and then correlates this 210 with the database of known annotated models 90.

If the expected usage is within the expected threshold limits 220 of what is considered “normal” operational usage of the system, the system continues to monitor 200.

If there is a variation exceeding one or more thresholds of resource usage 230, the system flags this event 230 and starts a timer. The system continues to monitor the event by measuring the variance in expected usage until the resource utilization 240 again moves to within the expected threshold.

If the timer exceeds a given value, the anomalous even is then considered to indefinite. Such instances may include for example, the addition of a new retail outlet. In this case, an increase in resource usage would be expected to continue indefinitely while the store remained open meaning that it is not an event but a permanent change in resource usage. In such cases, the timer can expire, and the new annotated event will be documented as unending.

If the max timer elapses or the resource utilization move back into the expected threshold 250 range (whether above or below the range) the system will attempt to automatically correlate the event 260 with known external events and feeds 100. The system will then add a new annotated model to the annotation model database 90 or adjust, if necessary, the one that matches the pattern that just occurred.

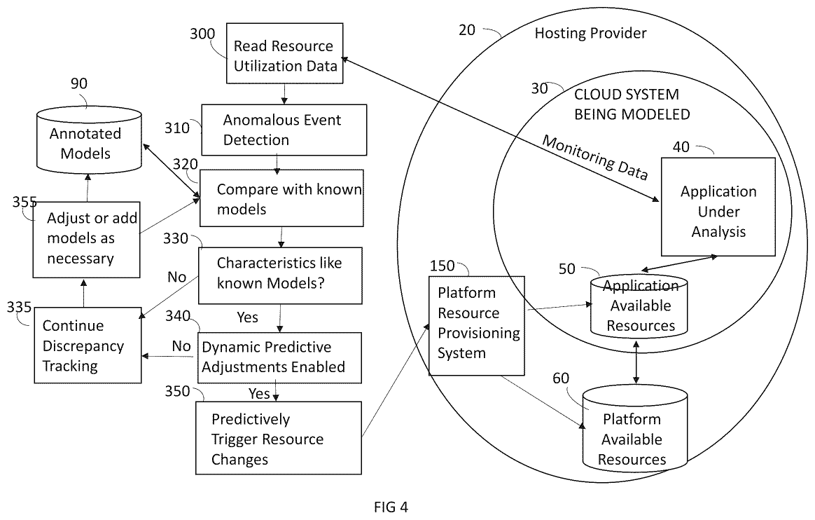

Referring to FIG. 4, the manner in which the system determines known trends within anomalous events and how the automatic triggering of resource changes is made with the hosting provider is illustrated.

The system reads the resource data 300 from the application under analysis 40, which is again part of the cloud system being modeled 30 running on a hosting provider 20. The Application under analysis 40 uses available resources 50, which are provided from a set of platform available resources 60 on the system. The allocation of these available resources 60 is done through a resource provisioning system 150 supported by the hosting provider 20, which allocates resources 60 to the application(s) 50 and charges for the resources 60 used.

Upon reading the utilization data 300, the system processes the readings as per FIG. 2, and if an anomalous event is detected 310, it is compared with known models 320 from the annotated model's database 90. If the anomalous event 310 resembles 320 and a previous known model 330 from the model's database 90, then the system will predictively 350 change the resource model through the platform resource provisioning system 150, provided the configuration of the system is set to allow dynamic adjustments 340.

Further, if there is a difference in the model 330 the system will continue to monitor, record and track 335 the anomaly. Once the system utilization falls back within normal bounds or the max times is exceeded as described in FIG. 3 the system will adjust or add 355 a new annotated model to the annotated model database 90.

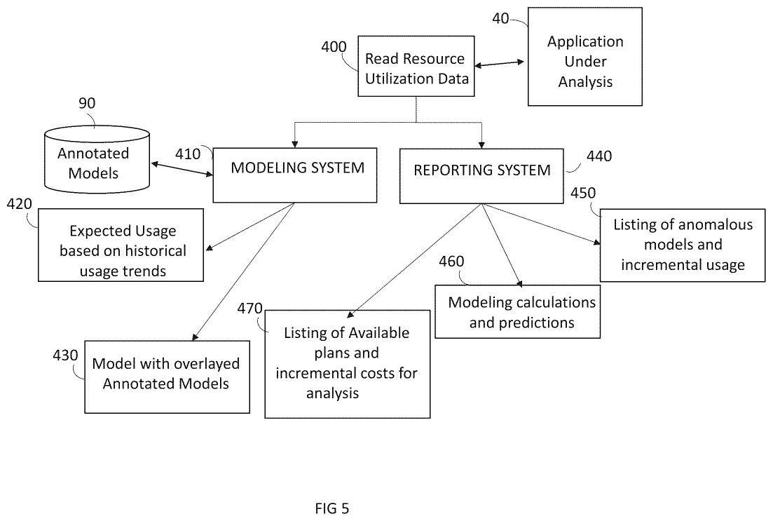

FIG. 5 outlines the reporting and modeling capabilities of the system. The system reads resource utilization data 400 from the application under analysis 40, and allows for both modelling 410 and reporting 440 functions.

The modeling 410 accesses the database on annotated models 90 and can report on the expected system resource utilization 420 based on historical trends, including the ability to overlay 430 known models over this usage. Thus, if the user of the system knows that there is a new spring sale planned for a coming day(s), they can model the usage predicted without the sale 420 and then overlay the expected sale data 430 from the annotated models 90 database.

For reporting 440, a number of reports are provided including a list of available plans 470 from the hosting provider. These include for example, cost analysis, the calculations and prediction of system resource usage 460 over time, and the list of known and detected anomalous models 450 in the system.

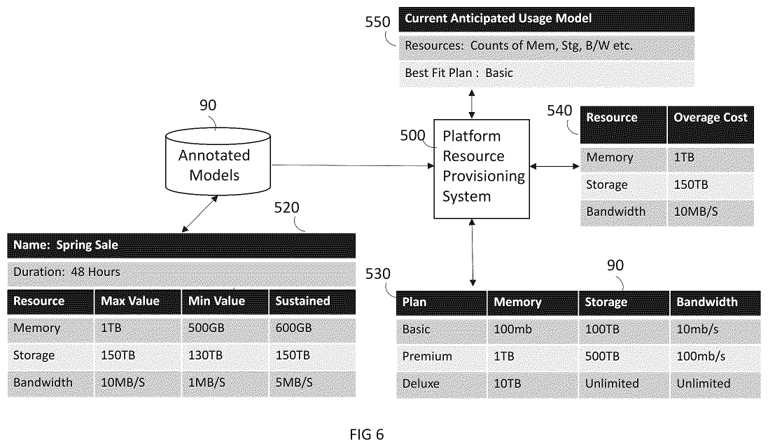

Referring now to FIG. 6, a tabular representation of resources and available plan mappings within the system is illustrated. The annotated model's database 90 contains known anomalous models, such as, the spring sale 520 used in the examples. Spring sale 520 has been documented as having a duration of 48 hours, and the number of resources expected incrementally are captured in the table 520.

Similarly, the platform resource provisioning system is familiar with the available plans of the hosting provider 530 as well as the overage costs of each individual resource type 540, and the anticipated 550 needs of the application.

For the resources that are not available, a value of infinity is added. As an example, a system having a fixed disk array of 10 TB cannot be expanded beyond these capabilities regardless of the cost, so no incremental overage cost can be shown. In such cases, the system flags that there are no appropriate plans, and the administrator can look to move to a different server with the existing hosting provider or change hosting providers. In some cases, the hosting provider may be adaptable and be willing to add more disk space. However there may also be system limitations such as addressing range, which impact the maximum values allowed and not simply the availability of the resources.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for monitoring hosted computing resource usage by applications comprising:
software executing on a computer, the software receiving usage information of a software application executing on at least one of a plurality of computing resources, the usage information indicative of usage of the at least one of the plurality of computing resources by the software application;
said software identifying usage variations based on the usage information and determining one or more anomalies in usage based on variation of usage compared to a threshold;
wherein the one or more anomalies are each tagged based on one or more event designators;
said software accessing one or more external sources to identify an occurrence of an event associated with a predicted future anomaly in usage of the at least one of the plurality of computing resources and based on the event compared to at least one of the one or more event designators, said software modifying availability of computing resources for execution of the software application.

2. The system of claim 1 wherein the software application is associated with a first hosting plan which relates use of the computing resources to a cost of executing said software application on the at least one of the plurality of computing resources and further comprising;
a cost limitation associated with the software application such that the cost limitation limits an amount of modification of availability of computing resources as compared to the cost limitation.

3. The system of claim 2 further comprising:
revenue information accessible by said software, the revenue information indicative of revenue associated with the software application and wherein the cost limitation adjusts based on the revenue information.

4. The system of claim 3 wherein the cost limitation is determined based on a ratio determined from usage information relative to the revenue information.

5. The system of claim 1 further comprising a user interface provided by said software application allowing user access to tag the one or more anomalies.

6. The system of claim 1 wherein the one or more external sources includes the software application.

7. The system of claim 1 wherein a baseline usage for the software application is determined by excluding at least one of the one or more anomalies and based on the predicted occurrence of the predicted future anomaly, availability of computing resources is modified for a period of time for an adjusted usage which includes the baseline usage and the at least one of the one or more anomalies.

8. The system of claim 1 wherein the inclusion of the at least one of the one or more anomalies in the adjusted usage increases availability of computing resources.

9. A method of monitoring hosted computer resource usage comprising:
providing software executing on a computer, the software receiving usage information of a software application executing on at least one of a plurality of computing resources, the usage information indicative of usage of the at least one of the plurality of computing resources by the software application;
with said software, identifying usage variations based on the usage information and determining one or more anomalies in usage based on variation of usage compared to a threshold;
said software accessing one or more external sources to identify an occurrence of an event associated with a predicted future anomaly in usage of the at least one of the plurality of computing resources and based on the event compared to a the one or more anomalies which are each a prior anomaly to the predicted future anomaly, said software modifying availability of computing resources for execution of the software application.

10. The method of claim 9 wherein said software modifies availability of computing resources by sending an instruction to a host provider associated with the at least one of the plurality of computing resources.

11. The method of claim 9 wherein the one or more anomalies are each tagged based on one or more event designators.

12. The method of claim 11 wherein the one or more event designators are compared to the event to determine a correlation between the event and the one or more event designators such that a size of the predicted future anomaly is predicted.

13. The method of claim 12 wherein the size of the predicted future anomaly determines how said software modifies availability of computing resources.

14. The method of claim 9 wherein the software application is associated with a first hosting plan which relates use of the computing resources to a cost of executing said software application on the at least one of the plurality of computing resources and;
an amount of the modification of availability of computing resources is determined in comparison to a cost limitation associated with the software application.

15. The method of claim 14 further comprising:
accessing revenue information with said software, the revenue information indicative of revenue associated with the software application and wherein the cost limitation adjusts based on the revenue information.

16. The system of claim 15 wherein the cost limitation is determined based on a ratio determined from usage information relative to the revenue information.

17. A system for monitoring hosted computing resource usage by applications comprising:
software executing on a computer, the software receiving usage information of a software application executing on at least one of a plurality of computing resources, the usage information indicative of usage of the at least one of the plurality of computing resources by the software application;
said software identifying usage variations based on the usage information and determining one or more anomalies in usage based on variation of usage compared to a threshold;
said software accessing one or more external sources to identify an occurrence of an event associated with a predicted future anomaly in usage of the at least one of the plurality of computing resources and based on the event compared one or more anomalies in usage which are past anomalies and based on the comparison, said software modifying availability of computing resources for execution of the software application.

18. The system of claim 17 wherein the software application is associated with a first hosting plan which relates use of the computing resources to a cost of executing said software application on the at least one of the plurality of computing resources and further comprising;
a cost limitation associated with the software application such that the cost limitation limits an amount of modification of availability of computing resources as compared to the cost limitation.

19. The system of claim 18 further comprising:
revenue information accessible by said software, the revenue information indicative of revenue associated with the software application and wherein the cost limitation adjusts based on the revenue information.

20. The system of claim 19 wherein the cost limitation is determined based on a ratio determined from usage information relative to the revenue information.
